(19) United States
(12) Patent Application Publication
(10) Pub. No.: US 2026/0243175 A1
(43) Pub. Date: Aug. 20, 2026

(54) FLANGE ASSEMBLY WITH WASHER FOR TURBOCHARGING SYSTEM

(71) Applicant: ACCELLERON SWITZERLAND LTD., Baden (CH)

(72) Inventors: Johannes SCHNAUS, Adliswil (CH); Philippe PANDOLFO, Wettingen (CH)

(21) Appl. No.: 18/872,398

(22) PCT Filed: Jun. 7, 2023
(86) PCT No.: PCT/EP2023/065273

§ 371 Date: Dec. 6, 2024

(30) Foreign Application Priority Data
Jun. 10, 2022 (EP) 22178341.8

(51) Int. Cl. F01D 25/24

(52) U.S. Cl. CPC F01D 25/243

(57) ABSTRACT

A flange assembly for a turbocharging system is described. The flange assembly comprises a housing component of the turbocharger system having a first flange portion; and an auxiliary component of the turbocharging system having a second flange portion. The housing component and the auxiliary component are attached to each other via the first and second flange portions with a plurality of fastening elements. The flange assembly further includes a washer at least partially arranged at and fixed to one of the first and second flange portions. Further, the use of a washer in a flange assembly of a turbocharging system is described herein.

### TECHNICAL FIELD

Embodiments of the present disclosure relate to a flange assembly for a turbocharging system. Further, embodiments of the present disclosure relate to the use of a washer in a flange assembly of a turbocharging system.

### BACKGROUND

Turbocharging systems contain several housing components and other auxiliary components, such as air inlet or exhaust gas components which are fixedly connected to each other by means of flange connections (e.g. by bolt connection of two flange joints).

During operation of the turbocharging system these components and the respective flange portions are subjected to high mechanical loads. The high mechanical stress can lead to failure of the components. Failure of mechanical components of the turbocharging system can result in damage “spreading” to other components of the turbocharging system, which may not be directly affected by the initial occurrence of the fault, or to damage occurring to external components.

For example, the flange of an air inlet component might break in or next to the openings in the flange which contain the attachment bolts. Even though the bolt may still be intact the bolt connection could be lost in such a scenario. These and related scenarios are to be avoided, in order to avoid a risk that too many bolt connections are lost and the air inlet might break and fall off the turbocharger. Another unwanted scenario may be due to an axial movement between the two components of the flange assembly, which may occur due to the inertia of one of the components (e.g. if the material characteristics of the two components differ). This may result in radial cracks in one or both of the flange portions of the components. Additionally, or alternatively rotation between the components of the flange assembly may occur due to the inertia of one of the components (e.g. if the material characteristics of the two components differ). In this scenario, is to be avoided that the flange may break in the outer part of the hole and/or that the bolt might slip out of the connection.

### SUMMARY

In light of the above, a flange assembly for a turbocharging system and the use of a washer in a flange assembly of a turbocharging system is provided to overcome at least some of the abovementioned limitations and/or reduce the risk of some unwanted scenarios. In particular, the object of the present invention is to provide a flange assembly which enables containment of damage, such as from spreading to other components not directly affected by the initial occurrence of a fault. This object is accomplished by means of a flange assembly according to claim 1 and the use of a washer according to claim 15. Further aspects, advantages, and features are apparent from the dependent claims, the description, and the accompanying drawings.

According to an aspect of the present disclosure, a flange assembly for a turbocharging system is provided. The flange assembly includes a housing component of the turbocharger system having a first flange portion. The flange assembly further includes an auxiliary component of the turbocharging system having a second flange portion. The housing component and the auxiliary component are attached to each other via the first and second flange portions with a plurality of fastening elements. The flange assembly includes a washer at least partially arranged at and fixed to one of the first and second flange portions. The washer includes a first radial inward portion and circumferentially spaced apart therefrom a second radial inward portion each containing a through-bore with a respective one of the fastening elements extending therethrough. The washer further includes a third radial inward portion circumferentially spaced apart from the first and second radial inward portions. The third radial inward portion is configured to provide a contact area for one of the first and second flange portions. The washer includes a connecting portion connected to each of the first, second and third radial inward portions.

The washer of the present disclosure contains at least two radial inward portions having a through-bore. The radial inward portions allow for connecting the washer with the auxiliary and the housing component by means of at least two fastening elements. In case the flange portions of one or more of the auxiliary and the housing component breaks at one fastening element connection, the flange assembly is held in place by the combination of the washer and the intact connection between fastening element and flange portions. The damaged component (auxiliary component or housing component) is protected from falling off the turbocharging system.

The washer of the present disclosure allows the contact area between washer and auxiliary or housing component to be increased. This is achieved, in particular, by providing the third radial inward portion, and preferably by having the first and second radial inward portion extending across the flange portion (of auxiliary or housing component). The increased contact area of the washer reduces the stress around the through-bore of the first and second radial inward portions, especially in case one of the auxiliary and the housing component breaks at one fastening element connection.

When reference is made to an axial, radial or circumferential directions herein, the respective direction is defined by the flange portions of the components, and in embodiments corresponds to the directions defined by the axis of the turbocharger. The axial direction is substantially perpendicular to the main surface of the flange portions of components.

The turbocharging system typically contains several components which are releasably connected to each other via flange portions. The invention is not limited to specific flange assemblies of a turbocharging system.

The flange assembly is preferably utilised for connecting components in case one of the components is brittle or where one of the components is more brittle than the other component. For example, the flange assembly of the present disclosure is particularly advantageous in case one of the components, such as the auxiliary component, is a casted aluminium component. The flange assembly of the present disclosure is particularly advantageous for air inlet components of the turbocharging system, the housings of which may be more brittle than other parts, especially if they are made of casted aluminium.

In an illustrative embodiment, the housing component is a housing component of a compressor of the turbocharging system. The component may house a rotating component of the turbocharging system, e.g. an impeller of the compressor.

Additionally, or alternatively, the auxiliary component may be an air inlet component of the turbocharging system. For example, the auxiliary component may be a silencer component, a suction branch, a compensator or a supply line component for connecting a first turbocharging stage with a second turbocharging stage, preferably a silencer.

The fastening elements of the flange assembly are not particularly limited, but preferably allow for a releasable connection between the (auxiliary and housing) components. Typically, the fastening element may be a screw or a combination of a bolt and two nuts or a combination of a stud bolt and a nut. For example, one of the (auxiliary or housing) components may have a stud bolt extending with a screw thread. The other component may include through-bores for receiving the stud bolts therethrough, and the components may be fixed to another by means of a nut. Alternatively, both of the (auxiliary or housing) components may include through-bores for receiving the attachment element.

The plurality of fastening elements is circumferentially arranged around the flange portions, and in particular around the radial outward end of the flange portions.

The washer is preferably arranged at a side of one of the components (auxiliary or housing) which faces away from the flange of the other component. In other words, the washer is preferably not arranged between the two flange portions of the components, but on the outside or outer side of one of the flanges (or first and second flange portions). Attachment of the first flange portion to the second flange portion with the plurality of fastening elements may result in a contact surface between the housing and the auxiliary component. The outside or outer side of each of the first and second flange portions are sides that face away from the contact surface. The washer may be formed of a metal. The washer may be disposed between the fastening element, in particular an end of the fastening element, and a side, in particular the outer side, of one of the flange portions. The washer may improve a connection between the flange portion and the fastening element.

In addition, the flange assembly may further include an O-ring, a gasket or other suitable means between the two flange portions of the housing and the auxiliary components. The gasket may be a shaped sheet for sealing a junction between the housing and the auxiliary components. The gasket and the washer are different components. Stated differently, the washer is not a gasket.

The fastening element may have an axial component extending through the washer, in particular the first and second radial inward portion of the washer, and further through the first or second flange portion and subsequently through the remaining flange portion (second or first).

The fastening element preferably has an axial end portion which is in direct contact with the washer, and in particular the first and second radial inward portions of the washer. The washer is preferably also in direct contact with one of the first or second flange portions. In other words, the washer may be axially clamped between the first or second flange portion and the axial end portion of the fastening element.

Preferably, the washer is axially disposed between the axial end portion of the fastening element and the second flange portion (i.e. the surface of the second flange portion facing away from the first flange portion) of the auxiliary component, especially when the auxiliary component is a brittle component, such as made of casted aluminium. Each of the first, second and third radial inward portions may be disposed above and in contact with second flange portion. Each of the first and second radial inward portions may be disposed between one of the fastening elements and the second flange portion of the auxiliary component.

The washer may be integrally formed, i.e. formed from one piece of material. For example, the washer may be formed from a sheet material. The first, second and third radial inward portions are preferably each flat and lie in one common plane.

The first, second and third radial inward portions of the washer may typically be entirely arranged within an outer perimeter of the flange portion (first or second). The first, second and third radial inward portions may be adjacent each other, but preferably do not contact each other and/or do not abut against each other. The washer does not form a continuous surface within the outer perimeter of the flange portion (first or second), but is interrupted by the radial inward portions being spaced apart from each other.

The connecting portion of the washer may also be considered as a radial outward portion of the washer. The connecting portion may typically be arranged largely or entirely radially outward from an outer perimeter or a radial end of the flange portion. The connecting portion may not be radially disposed or clamped between flange portion and fastening element. The connecting portion may not be in contact with the fastening element and/or the flange portion.

The connecting portion may have several sections. Illustratively, the connecting portion may include one section for each radial inward portion of the washer, and optionally one section for connecting these sections. Alternatively, the connecting portion may include two sections; a first section connecting the first and third radial inward portions and a second section connecting the third and second radial inward portion. The sections of the connecting portions may differ, e.g. in their radial and/or circumferential dimensions.

The washer may include any number (but at least three) of radial inward portions, with each radial inward portion being circumferentially spaced from an adjacent radial inward portion. For example, the washer may contain a fourth radial inward portion containing a through-bore with a respective one of the fastening elements extending therethrough and/or a fourth radial inward portion not containing a through-bore.

The radial inward portions may be spaced apart from each other in a circumferential direction. Thereby, radial recesses may be formed between pairs of circumferentially neighbouring radial inward portions. The radial recesses may be delimited, in a circumferential direction by the respective pair of neighbouring radial inward portions, and in a radially outward direction by the connecting portion. The radial recesses may be open at a radially inward side of the recesses. At least one of the radial recesses may extend further radially outside than the flange.

In particular, a first radial recess may be defined between the first and third radially inward portions; and a second radial recess may be defined between the second and third radially inward portions. The first radial recess may extend radially further outside than the second radial recess. The radial recesses allow accommodating stabilizing structures (e.g., struts) extending through the flange region therein, while the connecting portions arranged radially outside of the radial recesses still allow connecting the radially inward portions to each other.

According to an embodiment, the third radial inward portion is configured to provide a contact area for one of the first and second flange portions between adjacent fastening elements. The third radial inward portion may provide a contact area in a space in which no fastening element is arranged. This allows for maximising the contact area of the washer with the flange portion, thereby reducing the stress around the through-bore of the first and second radial inward portions, especially in case one of the auxiliary and the housing component breaks at one fastening element connection. The third radial inward portion may preferably be arranged between and spaced apart from adjacent fastening elements.

According to an embodiment, the third radial inward portion is circumferentially arranged between the first and the second radial inward portion. The third radial inward portion may provide an additional contact area in a space which is not or cannot be occupied by the first or second radial inward portions.

In one illustrative embodiment, the third radial inward portion does not contain a bore. The third radial inward portion may provide an additional contact area in a section which does not include a fastening element.

The washer may also have more than two radial inward portions containing through-bores, such as three or four (fourth, sixth, etc. radial inward portion). In this case, an additional intermediate (fifth, seventh, etc) radial inward portion may be arranged between each adjacent pair of radial inward portions containing through-bores.

According to an embodiment, the washer is substantially flat. Thus, all portions of the washer may be flat, including the first, second, third and the connection portion. Each of the first, second, third and the connection portion may lie in one common plane. Producing the washer such that it is flat facilitates assembly of the flange portions. Preferably, the washer may be made of a sheet material.

According to another embodiment, the washer may not be flat. The first, second and third radial inward portions may be arranged in a common plane. The connecting portion may define a connecting plane. The connecting plane may be arranged at an angle with respect to the common plane. For example, the angle between the common plane and the connecting plane may be in the range between 80° and 120°. Preferably, the common plane is substantially perpendicular with respect to the connecting plane. The connecting portion may be substantially flat, in particular apart from a bent section in contact with the first, second and third radial inward portions. The washer may be made of a sheet material.

The connecting portion may substantially extend along an axial longitudinal direction, and in particular not along a radial direction. Advantageously, the connecting portion may provide a radial barrier for fastening elements in case of damage to the flange assembly. Thus, in case one or both of the flange portions breaks in the vicinity of one fastening element, the fastening element may come lose. However, the connecting portion extending along the axial longitudinal direction prevents the fastening element from slipping out of the flange assembly, and in particular from radially slipping past the washer. Thus, broken parts of the flange assembly may be contained within the flange assembly instead of causing damage to any further components, e.g. of the turbocharging system.

The flange assembly according to embodiments of the present disclosure may also include several washers as described herein. For example, the flange assembly may contain between 3 and 8 washers.

According to another embodiment, the flange assembly may include a second washer different from the washer described above (which may also be referred to as the first or first type of washer).

The second (or second type of) washer may be at least partially arranged at and fixed to one of the first and second flange portions. The second washer may further include a radial inward flat portion having one through-bore with a fastening element extending therethrough. Preferably, the second washer has one single through-bore and/or no additional radial inward portion(s). The second washer may further include a radial outward portion arranged at an angle with the radial inward flat portion. The angle between the radial inward portion and the radial outward portion may be in the range between 80° and 120°. Preferably, the radial inward flat portion is substantially perpendicular to the radial outward portion.

The radial outward portion of the washer may substantially extend along an axial longitudinal direction. Advantageously, the radial outward portion of the second washer may provide a radial barrier for fastening elements in case of damage to the flange assembly. Thus, in case one or both flange portions break in the vicinity of the fastening element clamping the second washer, the fastening element may come lose. However, the radial outward portion extending along the axial longitudinal direction prevents the fastening element from slipping out of the flange assembly, and in particular from radially slipping past the second washer. Thus, broken parts of the flange assembly may be contained within the flange assembly instead of causing damage to any further components, e.g. of the turbocharging system.

The remarks above relating to the (first) washer with respect to the arrangement within the flange assembly apply accordingly to the second washer (e.g. the arrangement with respect to the first, and second flange portions and the attachment elements).

Typically, the flange assembly may include several first washers and several second washers. The second washer is small compared to the first washer and can be used around circumferential sections of the flange assembly in which the space is too limited to accommodate the first washer. The second washer is simple to install when fixing the flange portions to each other with the fastening elements. The combination of second washer with flat first washers is particularly advantageous. Both are easy to install and work together in containing the flange assembly in case of damage. Illustratively, the flange assembly may include 2-4 first washers and 1-4 second washers.

According to an embodiment, the auxiliary component and/or the housing component, preferably the auxiliary component, includes a plurality of struts circumferentially arranged at the flange portion. The struts may extend along a radial outer section of the (first and/or second) flange portion, in particular to the radial outer end of the (first and/or second) flange portion. Stated differently, a radial outward end or end portion of the (first and/or second) flange portion may be interrupted by the struts. For example, the struts may be part of the auxiliary component, such as when the auxiliary component is a silencer. The struts may support a housing component of the silencer. The struts may preferably be arranged at the surface of the second flange portion facing away from the first flange portion. Illustratively, the struts may be arranged adjacent the axial end portion of the fastening element and the washer.

Each of the first, second and third radial inward portion of the washer may be disposed between an adjacent pair of struts. Preferably, only one of the first, second and third radial inward portions is disposed between one given adjacent pair of struts. The third inward portion may then be disposed between the neighbouring adjacent pair of struts. One or more of the first, second and third radial inward portions may largely or entirely span the circumferential length (arc length) between adjacent struts. This allows for maximising the contact area between the (first, second, and third) radial inward portions and the flange portion.

The struts may not be equidistantly spaced around the circumference of the flange portion. Additionally, or alternatively, the struts may differ in radial length and/or circumferential length. The first washer is particularly advantageous for use within sections of the flange assembly in which the space is not too confined by struts. The second washer is particularly advantageous for use within sections of the flange assembly in which the space is rather confined due to the small size and the simple installation of the second washer.

The connecting portion of the (first) washer may circumferentially extend past at least two struts. The connecting portion may include a radial inward gap for accommodating each strut. Typically, the connecting portion may circumferentially extend past two struts and include two radial inward gaps with one strut being arranged within each radial inward gap. One section of the connecting portion may connect the first and third radial inward portion and extend past one strut. Another section of the connecting portion may connect the third and second radial inward portion and extend past another strut.

The connecting portion of the (first) washer may circumferentially extend radially outward from and circumferentially along at least two struts.

The struts may not be equidistantly spaced around the circumference of the flange portion and may differ in radial length or arc length. The connecting portion may include corresponding sections having different arc lengths and/or different radial lengths.

According to an aspect of the present disclosure, a turbocharging system is provided. The turbocharging system includes the flange assembly according to any embodiment described herein.

Another aspect of the present disclosure is directed to the use of a washer in a flange assembly of a turbocharging system for containing the turbocharging system in case of damage to the flange assembly. The washer includes a first radial inward portion and circumferentially spaced apart therefrom a second radial inward portion each containing a through-bore for receiving a fastening element therethrough. The washer further includes a third radial inward portion circumferentially spaced apart from the first and second radial inward portions. The third radial inward portion is configured to provide a contact area for a flange portion of the turbocharging system. The washer also includes a connecting portion connected to each of the first, second and third radial inward portions.

The washer may be provided according to any embodiment described in the present disclosure. Thus, the washer may contain any of the features above described with respect to the flange assembly.

The third radial inward portion is preferably configured to provide a contact area for a flange portion of the turbocharging system between adjacent fastening elements.

According to an aspect of the present disclosure a washer for a flange assembly in a turbocharging system is provided. The washer includes a first radial inward portion and circumferentially spaced apart therefrom a second radial inward portion each containing a through-bore for receiving a fastening element therethrough. The washer further includes a third radial inward portion circumferentially spaced apart from the first and second radial inward portions. The third radial inward portion is configured to provide a contact area for a flange portion of the turbocharging system. The washer also includes a connecting portion connected to each of the first, second and third radial inward portions.

The washer may be provided according to any embodiment described in the present disclosure. Thus, the washer may contain any of the features above described with respect to the flange assembly.

The third radial inward portion is preferably configured to provide a contact area for a flange portion of the turbocharging system between adjacent fastening elements.

Those skilled in the art will recognise additional features and advantages upon reading the following detailed description, and upon viewing the accompanying drawings.

### BRIEF DESCRIPTION OF THE DRAWINGS

The components in the Figures are not necessarily to scale, instead emphasis being placed upon illustrating the principles of the invention. Moreover, in the Figures, like reference signs designate corresponding parts. The accompanying drawings relate to embodiments of the disclosure and are described in the following:

FIG. 1 shows a schematic view of a turbocharging system and a flange assembly according to embodiments described herein;

FIG. 2a shows a schematic top view of a flange assembly according to embodiments described herein;

FIG. 2b shows a schematic side view of the flange assembly shown in FIG. 2a;

FIG. 2c shows a schematic view of the flange assembly shown in FIG. 2a along lines B-B;

FIG. 2d shows a schematic view of the flange assembly shown in FIG. 2a along lines A-A;

FIG. 3 shows a schematic view of a washer according to further embodiments described herein;

FIG. 4a shows a schematic view of another washer according to further embodiments described herein; and

FIG. 4b shows a side view of the washer shown in FIG. 4a along lines B-B.

### DETAILED DESCRIPTION OF EMBODIMENTS

Reference will now be made in detail to the various embodiments, one or more examples of which are illustrated in each figure. Each example is provided by way of explanation and is not meant as a limitation. For example, features illustrated or described as part of one embodiment can be used on or in conjunction with any other embodiment to yield yet a further embodiment. It is intended that the present disclosure includes such modifications and variations.

Within the following description of the drawings, the same reference numbers refer to the same or to similar components. Generally, only the differences with respect to the individual embodiments are described. Unless specified otherwise, the description of a part or aspect in one embodiment can apply to a corresponding part or aspect in another embodiment as well.

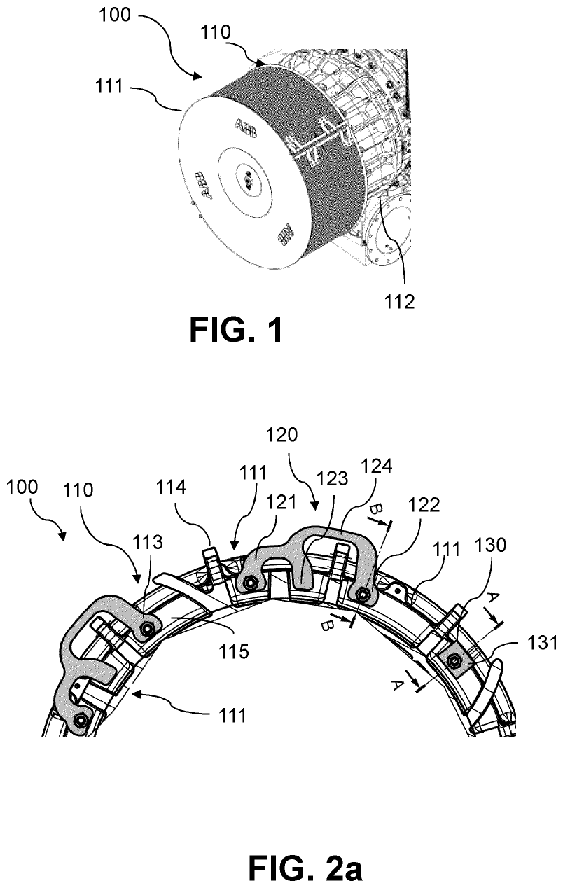

With exemplary reference to FIG. 1, a turbocharging system 100 including a flange assembly 110 according to the present disclosure is described. The flange assembly 110 includes a housing component 112 of the turbocharger system 100 and an auxiliary component 111 of the turbocharging system.

FIG. 1 illustrates one of the possible flange assemblies included in the turbocharging system 100. In the particular example shown in FIG. 1, the housing component 112 is a component of a compressor. The component 112 houses an impeller of the compressor. The auxiliary component 111 is a silencer. The silencer 111 is releasably fixed to the component 112 of the compressor. The silencer 111 and the component 112 are attached to each other via first and second flange portions with a plurality of fastening elements. However, silencer 111 obscures the view of the flange assembly in FIG. 1.

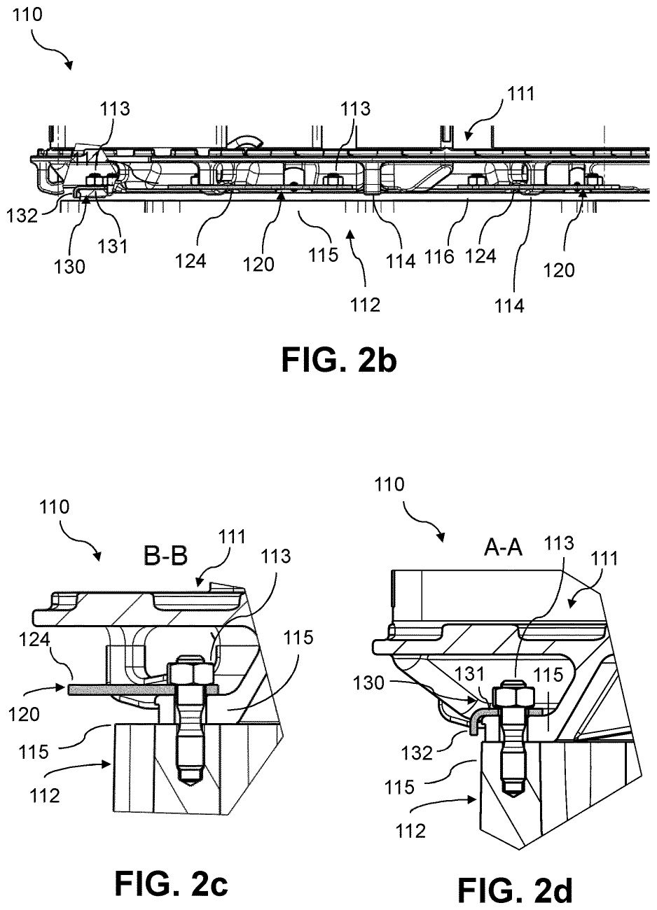

FIG. 2a shows a schematic top view of parts of the flange assembly 110 according to embodiments described herein, and FIG. 2b shows a side view of the embodiment of FIG. 2a. Some parts of the components are cut away for reasons of clarity. In FIG. 2a, parts of the auxiliary component 111 are cut away to allow a better view of the components of the flange assembly. In FIG. 2b, the top of the auxiliary component 111 and the bottom part of the housing component 112 are cut away.

FIG. 2a shows the auxiliary component 111 (the housing component is largely not visible in FIG. 2a, but visible in FIG. 2b). The auxiliary component includes a second flange portion 115. The second flange portion 115 has a first side or surface in contact with a side or surface of the first flange portion 116. These two sides form a flange joint. The second flange portion 115 also has a second side or surface facing away from the first flange portion 116.

The flange assembly 110 includes a plurality of struts 114 circumferentially spaced around a radial outer section of the second side of the flange portion 115. The struts 114 may be provided for different purposes and therefore are not necessarily equidistantly spaced nor have an equal arc length. Some struts may also not extend all the way to the radial outer end of the second side and provide a space at the radial outer end of the second side of the second flange portion 115.

The second flange portion 115 is releasably attached to the first flange portion 116 by means of a plurality of fastening elements 113. In the example shown in FIG. 2, the fastening elements 113 are a combination of a stud bolt and a nut.

The flange assembly 110 further includes at least one (first) washer 120. The portion of the flange assembly 110 shown in FIG. 2a shows two washers 120, but the flange assembly 110 can have more or less than two washers 120.

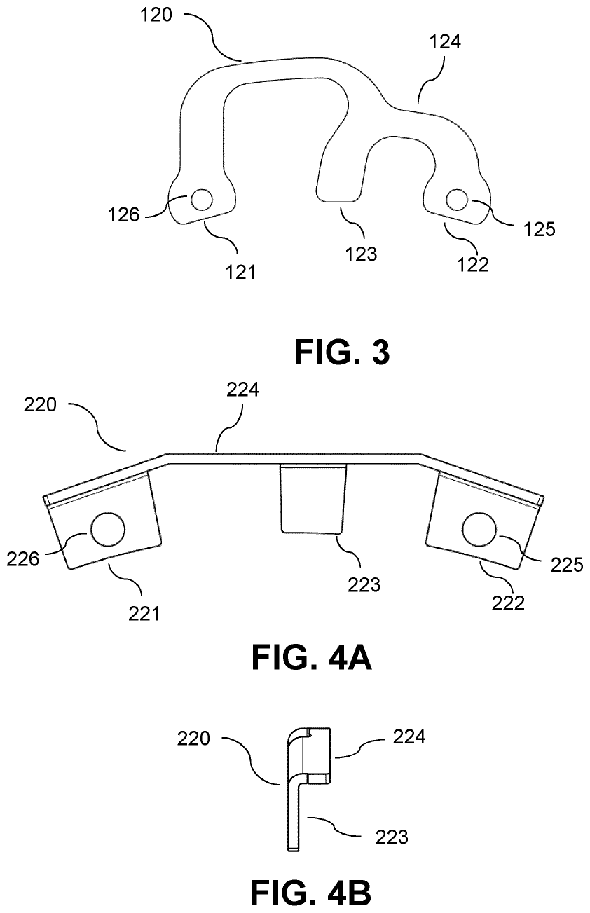

FIG. 3 illustrates a washer 120 according to embodiments of the present disclosure. The washer includes a first radial inward portion 121, a second radial inward portion 122, a third radial inward portion 123 and a connecting portion 124.

The first radial inward portion 121 contains a through-bore 126 to accommodate a fastening element 113 therein. The second radial inward portion 122 also contains a through-bore 125 to accommodate a fastening element 113 therein.

The third radial inward portion 123 preferably does not have a through-bore for accommodating a fastening element 113. The third radial inward portion 123 provides a contact area for the second flange portion 115 between adjacent fastening elements 113.

Each of the first, second, and third radial inward portion are circumferentially spaced apart from each other. The first, second and third radial inward portions are adjacent to each other, but not in contact with another and do not abut each other. Each of the first, second, and third radial inward portions are preferably flat and configured to contact the second side of the flange portion facing away from the other flange portion. The radial inward portion allow for full-surface contact with the second side of the flange portion.

The third radial inward portion 123 is circumferentially arranged between the first and the second radial inward portion 121, 122.

The connecting portion 124 contains two sections with one section connecting the third and second radial inward portion and another section connecting the first radial inward portion 121. In the particular example shown in FIG. 3, the two sections each form a gap configured to accommodate a strut. The two sections have different radial depths and form differently sized gaps in correspondence with the size of the struts 114 of the flange assembly 110. The sections of the connecting portion 124 may differ in size and shape from that shown in FIG. 3, depending on the type and size of the struts 114 of the flange assembly.

The washer 120 shown in FIG. 2a is substantially flat, and integrally formed from a sheet material.

Referring back to FIG. 2a, the plurality of fastening elements 113 attach the second flange portion 115 to the first flange portion 116. As further illustrated in FIG. 2c, the washer 120 is clamped between the axial end portion of the fastening element 113 and the second side of the second flange portion 115. This may be realised by inserting the fastening element 113 into through-bores 125, 126 of first and second radial inward portions, and through openings in the second flange portion 115 and optionally the first flange portion 116. FIG. 2c shows a side view of FIG. 2a along lines B-B.

The third radial inward portion 123 contacts the second side of the second flange portion 116 in between adjacent fastening elements 113 and in between adjacent struts 114. Thus, the contact area between washer and second flange portion is maximised.

According to an embodiment, the flange assembly 110 (as also illustrated in FIGS. 2a and 2b) further includes a second washer 130. The second washer is fixed to the second flange portion 115 by means of one fastening element 113. The second washer 130 is clamped between the axial end portion of the fastening element 113 and the second surface of second flange portion 115. The second washer 130 contains a radial inward flat portion 131 having one through-bore and a radial outward portion 132 arranged at an angle with the radial inward flat portion 131. The angle is approximately 90°. FIG. 2 d shows a side view of FIG. 2a cut along lines A-A. The radial outward portion 132 being bent with respect to the radial inward portion 131 is visible in FIG. 2d.

The radial outward portion 132 of the second washer 130 provides a radial barrier for fastening element 113 in case of damage to the flange assembly.

FIGS. 4a and 4b illustrate a washer 220 according to another embodiment of the present disclosure. FIG. 4b is a side view of FIG. 4a.

The washer 220 is largely identical to washer 120 unless indicated otherwise. The washer 220 may also be used in the same flange assembly 110 illustrated in FIG. 2. The washer 220 can also be combined with second washer 130 described above with reference to FIG. 2.

Washer 220 includes a first radial inward portion 221, a second radial inward portion 222, a third radial inward portion 223 and a connecting portion 224. The first radial inward portion 221 and the second radial inward portion 222 each contain a through-bore 225, 226 to accommodate a fastening element 113 therein.

The first, second and third radial inward portions 221, 222, 223 are arranged in a common plane and the connecting portion 224 defines a connecting plane arranged at an angle with respect to the common plane. The angle is approximately 90°.

Hence, in view of the above, it is to be understood that compared to the state of the art, the embodiments described allow for containment of the flange assembly in case of damage. The fixation of the washer via at least two fastening elements, the extended contact surface, and optionally the radial barrier, allow for containing the flange assembly in case one or both of the flanges break in the outer part of the hole (opening).

While the foregoing is directed to embodiments, other and further embodiments may be devised without departing from the basic scope, and the scope is determined by the claims that follow.

### REFERENCE NUMERALS

100 turbocharging system
110 flange assembly
111 auxiliary component
112 housing component
113 fastening elements
114 struts
115 second flange portion
116 first flange portion
120, 220 washer
121, 221 first radial inward portion
122, 222 second radial inward portion
123, 223 third radial inward portion
124, 224 connecting portion
125, 126, 225, 226 through-bore
130 second washer

1. A flange assembly for a turbocharging system comprising:
a housing component of the turbocharger system having a first flange portion; and
an auxiliary component of the turbocharging system having a second flange portion; wherein the housing component and the auxiliary component are attached to each other via the first and second flange portions with a plurality of fastening elements;
a washer at least partially arranged at and fixed to one of the first and second flange portions, wherein the washer is essentially arranged on an outer side of one of the first and second flange portions, the washer comprising:
a first radial inward portion and circumferentially spaced apart therefrom a second radial inward portion each containing a through-bore with a respective one of the fastening elements extending therethrough;
a third radial inward portion circumferentially spaced apart from the first and second radial inward portions, wherein the third radial inward portion is configured to provide a contact area for one of the first and second flange portions; and
a connecting portion connected to each of the first, second and third radial inward portions.

2. The flange assembly of claim 1, wherein the third radial inward portion is configured to provide a contact area for one of the first and second flange portions between adjacent fastening elements.

3. The flange assembly of claim 1, wherein the third radial inward portion is circumferentially arranged between the first and the second radial inward portion.

4. The flange assembly of claim 1, wherein each of the first radial inward portion and the second radial inward portion are disposed between one of the fastening elements and the second flange portion of the auxiliary component.

5. The flange assembly of claim 1, wherein the third radial inward portion does not contain a bore.

6. The flange assembly of claim 1, wherein the connecting portion is arranged radially outward of a radial end of the flange portions.

7. The flange assembly of claim 1, wherein the washer is substantially flat.

8. The flange assembly of claim 1, wherein the first, second and third radial inward portions are arranged in a common plane and the connecting portion defines a connecting plane arranged at an angle with respect to the common plane.

9. The flange assembly of claim 1, wherein the connecting portion substantially extends along an axial longitudinal direction and/or is configured to provide a radial barrier for fastening elements in case of damage to the flange assembly.

10. The flange assembly of claim 1, wherein the housing component is a housing component of a compressor of the turbocharging system, and houses a rotating component of the turbocharging system.

11. The flange assembly of claim 1, wherein the auxiliary component is an air inlet component of the turbocharging system.

12. The flange assembly of claim 1, wherein the auxiliary component is a casted aluminium air inlet component and/or the auxiliary component and the housing component differ in brittleness and the washer is arranged at the more brittle flange.

13. The flange assembly of claim 1, further comprising a second washer at least partially arranged at and fixed to one of the first and second flange portions, the second washer containing a radial inward flat portion having one through-bore with a fastening element extending therethrough, wherein the second washer further contains a radial outward portion arranged at an angle with the radial inward flat portion.

14. The flange assembly of claim 1, wherein the auxiliary component has a plurality of struts circumferentially arranged at the flange portion.

15. A use of a washer in a flange assembly of a turbocharging system for containing the turbocharging system in case of damage to the flange assembly, wherein the washer is configured to be essentially arranged on an outer side of a flange portion of the flange assembly, the washer, comprising:
a first radial inward portion and circumferentially spaced apart therefrom a second radial inward portion each containing a through-bore for receiving a fastening element therethrough;
a third radial inward portion circumferentially spaced apart from the first and second radial inward portions, wherein the third radial inward portion is configured to provide a contact area for a flange portion of the turbocharging system; and
a connecting portion connected to each of the first, second and third radial inward portions.

16. The flange assembly of claim 1, wherein the auxiliary component is a silencer component, a suction branch, a compensator or a supply line component for connecting a first turbocharging stage with a second turbocharging stage.

17. The flange assembly of claim 13, wherein the radial inward flat portion is substantially perpendicular to the radial outward portion.

18. The flange assembly of claim 14, wherein each of the first, second and third radial inward portions of the washer are disposed between adjacent struts.
